(19) United States
(12) Patent Application Publication
(10) Pub. No.: US 2022/0413988 A1
(43) Pub. Date: Dec. 29, 2022

(54) ELECTRONIC DEVICE AND METHOD FOR PROCESSING USER INPUT

(71) Applicant: Samsung Electronics Co., Ltd., Gyeonggi-do (KR)

(72) Inventors: Bokyum KIM, Gyeonggi-do (KR); Jungkeun CHO, Gyeonggi-do (KR); Jaeyung YEO, Gyeonggi-do (KR)

(21) Appl. No.: 17/898,627

(22) Filed: Aug. 30, 2022

Related U.S. Application Data
(63) Continuation of application No. PCT/KR2021/002434, filed on Feb. 26, 2021.

(30) Foreign Application Priority Data
Mar. 3, 2020 (KR) 10-2020-0026311

(51) Int. Cl. G06F 11/34; G06F 3/16

(52) U.S. Cl. CPC G06F 11/3452; G06F 3/16

(57) ABSTRACT

Disclosed herein are an electronic device and method thereof. The electronic device includes an input device; an output device; a processor operatively connected to the input device and the output device; and a memory operatively connected to the processor, wherein the memory stores instructions. The instructions are executable by the processor to implement the method, including identifying a function for executing the user input, based at least on input data corresponding to the user input; classifying the identified function based on executability of the function; determining a completion possibility of the classified function; and providing response data via the output device based on a result of the classifying and the completion probability.

### CROSS-REFERENCE TO RELATED APPLICATION(S)

This application is a continuation of International Application No. PCT/KR2021/002434, which was filed on Feb. 26, 2021, and claims priority to Korean Patent Application No. 10-2020-0026311, filed on Mar. 3, 2020, in the Korean Intellectual Property Office, the disclosures of which are incorporated by reference herein their entirety.

### BACKGROUND

### Technical Field

The disclosure relates to a technology of processing a user input, in particular, a user utterance.

### Description of Related Art

Electronic devices now support a variety of input methods, such as voice input, in addition to conventional input methods, such as keyboard or mouse. For example, the electronic devices such as smart phones or tablet PCs may receive a user's vocal utterance, and provide a service for performing an operation, as corresponding to the received user utterance.

Speech recognition service are undergoing continual development. Such services include technology for processing natural language inputs generated by users. Natural language technology is able to grasp an intent of a user utterance, generate a result matching the intent, and provide a user with a corresponding service according to the result.

Another type of service is the voice recognition service, which provide a so-called “quick command” function enabling the electronic device to automatically perform multiple functions upon receiving a single predefined input (e.g., utterance) from the user. However, when a user adds a desired function to the quick command function, the device does may fail to determine whether the function includes a suitable configuration for the quick command.

### SUMMARY

The present disclosure provides an electronic device and method thereof capable of providing feedback to a user by identifying a function included in a configuration required by an electronic device to execute a user input and determining whether the function has a suitable configuration of the user input.

The present disclosure provides an electronic device and method thereof which can determine whether a function corresponding to a user input is an executable function or a function causing a problem in a quick command operation.

According to certain embodiments of the disclosure, an electronic device is disclosed, including an input device; an output device; a processor operatively connected to the input device and the output device; and a memory operatively connected to the processor, wherein the memory stores instructions that are executable by the processor to cause the electronic device to: receive a user input via the input device; identify a function for executing the user input, based at least on input data corresponding to the user input; classify the identified function based on executability of the function; determine a completion possibility of the classified function; and provide response data via the output device based on a result of the classifying and the completion probability.

According to certain embodiments of the disclosure, a method of an electronic device is disclosed, including: receiving a user input, via an input device included in the electronic device; identifying, via a processor, a function for executing the user input, based at least on input data corresponding to the user input; classifying, via the processor, the identified function based on executability of the function; determining, via the processor, a completion possibility of the classified function; and providing response data via an output device included in the electronic device, based on a result of the classifying and the completion probability.

According to certain embodiments of the disclosure, it is possible to improve the accuracy of operations upon reception of the corresponding triggering user inputs.

According to certain embodiments of the disclosure, a method and electronic device are provided for identifying whether a function included in the configuration for executing an user input is executable and providing a feedback to a user. Accordingly, when a user adds one or more functions, the electronic device may determine executability of each function, and thus estimate the probable success of the configuration, so as to indicate to the user the same.

Furthermore, a variety of effects and advantages may be further understood or inferred directly or indirectly through the specification.

### BRIEF DESCRIPTION OF THE DRAWINGS

FIG. 1 is a block diagram illustrating an integrated intelligence system, according to an embodiment.

FIG. 2 is a diagram illustrating the form in which relationship information between a concept and an action is stored in a database, according to an embodiment.

FIG. 3 is a view illustrating a user terminal displaying a screen of processing a voice input received through an intelligence app, according to an embodiment.

FIG. 4 is a block diagram of an electronic device in a network environment, according to certain embodiments.

FIG. 5 is a block diagram of a program, according to certain embodiments.

FIG. 6 is a block diagram illustrating a structure of an electronic device, according to an embodiment disclosed in the specification.

FIG. 7 is a flowchart illustrating a method, in which an electronic device processes a user input, according to certain embodiments.

FIG. 8 is a flowchart illustrating a method in which an electronic device classifies a function corresponding to a user input, according to certain embodiments.

FIG. 9 is a flowchart illustrating a method in which an electronic device determines whether a function corresponding to a user input is an interaction function, according to certain embodiments.

FIG. 10 is a flowchart illustrating a method in which an electronic device determines completion possibility of a function corresponding to a user input, according to certain embodiments.

FIG. 11 is an example diagram of a configuration of a shortcut command created based on a user input.

FIG. 12 is an example diagram of response data provided by an electronic device to a user.

FIG. 13 is an example view of a screen provided by an electronic device to receive additional information about a parameter.

FIG. 14 is an example diagram of an altered configuration provided by an electronic device by reflecting an input for response data of a user.

With regard to description of drawings, the same or similar components will be marked by the same or similar reference signs.

### DETAILED DESCRIPTION

Hereinafter, certain embodiments of the disclosure may be described with reference to accompanying drawings. However, it should be understood that this is not intended to limit the disclosure to specific implementation forms and includes various modifications, equivalents, and/or alternatives of embodiments of the disclosure.

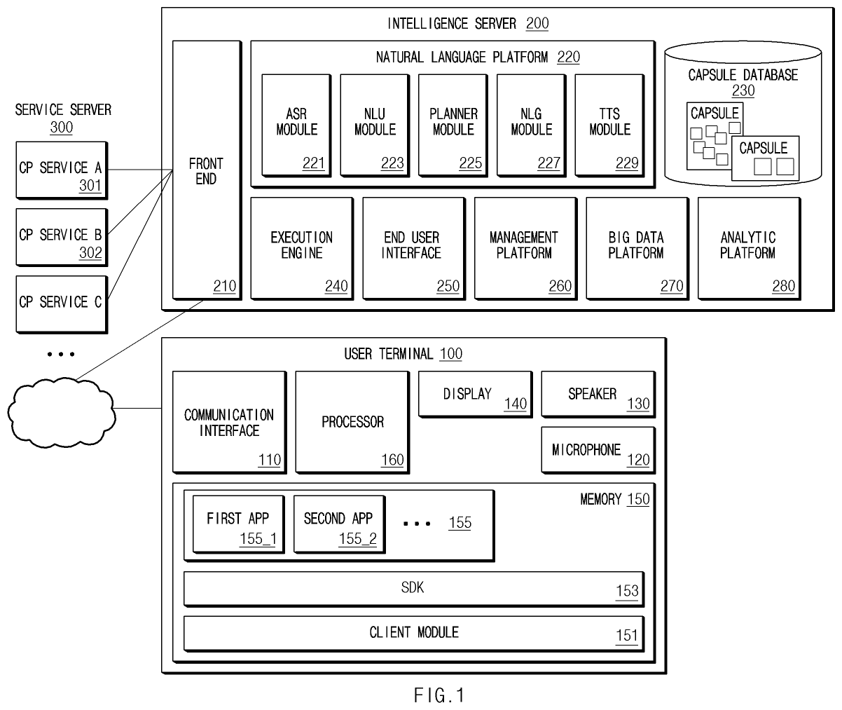

FIG. 1 is a block diagram illustrating an integrated intelligence system, according to an embodiment.

Referring to FIG. 1, an integrated intelligence system according to an embodiment may include a user terminal 100, an intelligence server 200, and a service server 300.

The user terminal 100 according to an embodiment may be a terminal device (or an electronic device 4401) capable of connecting to Internet, and may be, for example, a mobile phone, a smartphone, a personal digital assistant (PDA), a notebook computer, a television (TV), a household appliance, a wearable device, ahead mounted display (HMD), or a smart speaker.

According to the illustrated embodiment, the user terminal 100 may include a communication interface 110, a microphone 120, a speaker 130, a display 140, a memory 150, or a processor 160. The listed components may be operatively or electrically connected to one another.

The communication interface 110 according to an embodiment may be connected to an external device and may be configured to transmit or receive data to or from the external device. The microphone 120 according to an embodiment may receive a sound (e.g., a user utterance) to convert the sound into an electrical signal. The speaker 130 according to an embodiment may output the electrical signal as sound (e.g., voice). The display 140 according to an embodiment may be configured to display an image or a video. The display 140 according to an embodiment may display the graphic user interface (GUI) of the running app (or an application program).

The memory 150 according to an embodiment may store a client module 151, a software development kit (SDK) 153, and a plurality of apps 155. The client module 151 and the SDK 153 may include a framework (or a solution program) for performing general-purposed functions. Furthermore, the client module 151 or the SDK 153 may include the framework for processing a voice input.

The plurality of apps 155 may be programs for performing a specified function. According to an embodiment, the plurality of apps 155 may include a first app 155_1 and/or a second app 155_3. According to an embodiment, each of the plurality of apps 155 may include a plurality of actions for performing a specified function. For example, the apps may include an alarm app, a message app, and/or a schedule app. According to an embodiment, the plurality of apps 155 may be executed by the processor 160 to sequentially execute at least part of the plurality of actions.

According to an embodiment, the processor 160 may control overall operations of the user terminal 100. For example, the processor 160 may be electrically connected to the communication interface 110, the microphone 120, the speaker 130, and the display 140 to perform a specified operation. For example, the processor 160 may include at least one processor.

Moreover, the processor 160 according to an embodiment may execute the program stored in the memory 150 so as to perform a specified function. For example, according to an embodiment, the processor 160 may execute at least one of the client module 151 or the SDK 153 so as to perform a following operation for processing a voice input. The processor 160 may control operations of the plurality of apps 155 via the SDK 153. The following actions described as the actions of the client module 151 or the SDK 153 may be the actions performed by the execution of the processor 160.

According to an embodiment, the client module 151 may receive a voice input. For example, the client module 151 may receive a voice signal corresponding to a user utterance detected through the microphone 120. The client module 151 may transmit the received voice input (e.g., a voice input) to the intelligence server 200. The client module 151 may transmit state information of the user terminal 100 to the intelligence server 200 together with the received voice input. For example, the state information may be execution state information of an app.

According to an embodiment, the client module 151 may receive a result corresponding to the received voice input. For example, when the intelligence server 200 is capable of calculating the result corresponding to the received voice input, the client module 151 may receive the result corresponding to the received voice input. The client module 151 may display the received result on the display 140.

According to an embodiment, the client module 151 may receive a plan corresponding to the received voice input. The client module 151 may display, on the display 140, a result of executing a plurality of actions of an app depending on the plan. For example, the client module 151 may sequentially display the result of executing the plurality of actions on a display. As another example, the user terminal 100 may display a part of results (e.g., a result of the last action) of executing the plurality of actions, on the display.

According to an embodiment, the client module 151 may receive a request for obtaining information utilized to calculate the result corresponding to a voice input, from the intelligence server 200. According to an embodiment, the client module 151 may transmit the utilized information to the intelligence server 200 in response to the request.

According to an embodiment, the client module 151 may transmit, to the intelligence server 200, information about the result of executing a plurality of actions depending on the plan. The intelligence server 200 may identify that the received voice input is correctly processed, by using the result information.

According to an embodiment, the client module 151 may include a speech recognition module. According to an embodiment, the client module 151 may recognize a voice input for performing a limited function, via the speech recognition module. For example, the client module 151 may launch an intelligence app for processing a specific voice input by performing an organic action, in response to a specified voice input (e.g., wake up!).

According to an embodiment, the intelligence server 200 may receive information associated with a user's voice input from the user terminal 100 over a communication network. According to an embodiment, the intelligence server 200 may convert data associated with the received voice input to text data. According to an embodiment, the intelligence server 200 may generate at least one plan for performing a task corresponding to the user's voice input, based on the text data.

According to an embodiment, the plan may be generated by an artificial intelligent (AI) system. The AI system may be a rule-based system, or may be a neural network-based system (e.g., a feedforward neural network (FNN) and/or a recurrent neural network (RNN)). Alternatively, the AI system may be a combination of the above-described systems or an AI system different from the above-described system. According to an embodiment, the plan may be selected from a set of predefined plans or may be generated in real time in response to a user's request. For example, the AI system may select at least one plan of the plurality of predefined plans.

According to an embodiment, the intelligence server 200 may transmit a result according to the generated plan to the user terminal 100 or may transmit the generated plan to the user terminal 100. According to an embodiment, the user terminal 100 may display the result according to the plan, on a display. According to an embodiment, the user terminal 100 may display a result of executing the action according to the plan, on the display.

The intelligence server 200 according to an embodiment may include a front end 210, a natural language platform 220, a capsule database 230, an execution engine 240, an end user interface 250, a management platform 260, a big data platform 270, or an analytic platform 280.

According to an embodiment, the front end 210 may receive a voice input received from the user terminal 100. The front end 210 may transmit a response corresponding to the voice input to the user terminal 100.

According to an embodiment, the natural language platform 220 may include an automatic speech recognition (ASR) module 221, a natural language understanding (NLU) module 223, a planner module 225, a natural language generator (NLG) module 227, and/or a text to speech module (TTS) module 229.

According to an embodiment, the ASR module 221 may convert the voice input received from the user terminal 100 into text data. According to an embodiment, the NLU module 223 may grasp the intent of the user, using the text data of the voice input. For example, the NLU module 223 may grasp the intent of the user by performing syntactic analysis or semantic analysis. According to an embodiment, the NLU module 223 may grasp the meaning of words extracted from the voice input by using linguistic features (e.g., syntactic elements) such as morphemes or phrases and may determine the intent of the user by matching the grasped meaning of the words to the intent.

According to an embodiment, the planner module 225 may generate the plan by using a parameter and the intent that is determined by the NLU module 223. According to an embodiment, the planner module 225 may determine a plurality of domains utilized to perform a task, based on the determined intent. The planner module 225 may determine a plurality of actions included in each of the plurality of domains determined based on the intent. According to an embodiment, the planner module 225 may determine the parameter utilized to perform the determined plurality of actions or a result value output by the execution of the plurality of actions. The parameter and the result value may be defined as a concept of a specified form (or class). As such, the plan may include the plurality of actions and/or a plurality of concepts, which are determined by the intent of the user. The planner module 225 may determine the relationship between the plurality of actions and the plurality of concepts stepwise (or hierarchically). For example, the planner module 225 may determine the execution sequence of the plurality of actions, which are determined based on the user's intent, based on the plurality of concepts. In other words, the planner module 225 may determine an execution sequence of the plurality of actions, based on the parameters utilized to perform the plurality of actions and the result output by the execution of the plurality of actions. Accordingly, the planner module 225 may generate a plan including information (e.g., ontology) about the relationship between the plurality of actions and the plurality of concepts. The planner module 225 may generate the plan by using information stored in the capsule DB 230 storing a set of relationships between concepts and actions.

According to an embodiment, the NLG module 227 may change specified information into information in a text form. The information changed in the text form may have a form of natural language utterance. The TTS module 229 according to an embodiment may change information in the text form to information in a voice form.

According to an embodiment, all or part of the functions of the natural language platform 220 may be also implemented in the user terminal 100.

The capsule DB 230 may store information about the relationship between the actions and the plurality of concepts corresponding to a plurality of domains. According to an embodiment, the capsule may include a plurality of action objects (or action information) and concept objects (or concept information) included in the plan. According to an embodiment, the capsule DB 230 may store the plurality of capsules in a form of a concept action network (CAN). According to an embodiment, the plurality of capsules may be stored in the function registry included in the capsule DB 230.

The capsule DB 230 may include a strategy registry that stores strategy information utilized to determine a plan corresponding to a voice input. When there are a plurality of plans corresponding to the voice input, the strategy information may include reference information for determining one plan. According to an embodiment, the capsule DB 230 may include a follow-up registry that stores information of the follow-up action for suggesting a follow-up action to the user in a specified context. For example, the follow-up action may include a follow-up utterance. According to an embodiment, the capsule DB 230 may include a layout registry storing layout information of information output via the user terminal 100. According to an embodiment, the capsule DB 230 may include a vocabulary registry storing vocabulary information included in capsule information. According to an embodiment, the capsule DB 230 may include a dialog registry storing information about dialog (or interaction) with the user. The capsule DB 230 may update an object stored via a developer tool. For example, the developer tool may include a function editor for updating an action object or a concept object. The developer tool may include a vocabulary editor for updating a vocabulary. The developer tool may include a strategy editor that generates and registers a strategy for determining the plan. The developer tool may include a dialog editor that creates a dialog with the user. The developer tool may include a follow-up editor capable of activating a follow-up target and editing the follow-up utterance for providing a hint. The follow-up target may be determined based on a target, the user's preference, or an environment condition, which is currently set. The capsule DB 230 according to an embodiment may be also implemented in the user terminal 100.

According to an embodiment, the execution engine 240 may calculate a result by using the generated plan. The end user interface 250 may transmit the calculated result to the user terminal 100. Accordingly, the user terminal 100 may receive the result and may provide the user with the received result. According to an embodiment, the management platform 260 may manage information used by the intelligence server 200. According to an embodiment, the big data platform 270 may collect data of the user. According to an embodiment, the analytic platform 280 may manage quality of service (QoS) of the intelligence server 200. For example, the analytic platform 280 may manage the component and processing speed (or efficiency) of the intelligence server 200.

According to an embodiment, the service server 300 may provide the user terminal 100 with a specified service (e.g., ordering food or booking a hotel). According to an embodiment, the service server 300 may be a server operated by the third party. According to an embodiment, the service server 300 may provide the intelligence server 200 with information for generating a plan corresponding to the received voice input. The provided information may be stored in the capsule DB 230. Furthermore, the service server 300 may provide the intelligence server 200 with result information according to the plan.

In the above-described integrated intelligence system, the user terminal 100 may provide the user with various intelligent services in response to a user input. The user input may include, for example, an input through a physical button, a touch input, or a voice input.

According to an embodiment, the user terminal 100 may provide a speech recognition service via an intelligence app (or a speech recognition app) stored therein. In this case, for example, the user terminal 100 may recognize a user utterance or a voice input, which is received via the microphone, and may provide the user with a service corresponding to the recognized voice input.

According to an embodiment, the user terminal 100 may perform a specified action, based on the received voice input, independently, or together with the intelligence server and/or the service server. For example, the user terminal 100 may launch an app corresponding to the received voice input and may perform the specified action via the executed app.

In an embodiment, when providing a service together with the intelligence server 200 and/or the service server, the user terminal 100 may detect a user utterance by using the microphone 120 and may generate a signal (or voice data) corresponding to the detected user utterance. The user terminal may transmit the voice data to the intelligence server 200 by using the communication interface 110.

According to an embodiment, the intelligence server 200 may generate a plan for performing a task corresponding to the voice input or the result of performing an action depending on the plan, as a response to the voice input received from the user terminal 100. For example, the plan may include a plurality of actions for performing the task corresponding to the voice input of the user and/or a plurality of concepts associated with the plurality of actions. The concept may define a parameter to be entered upon executing the plurality of actions or a result value output by the execution of the plurality of actions. The plan may include relationship information between the plurality of actions and/or the plurality of concepts.

According to an embodiment, the user terminal 100 may receive the response by using the communication interface 110. The user terminal 100 may output the voice signal generated in the user terminal 100 to the outside by using the speaker 130 or may output an image generated in the user terminal 100 to the outside by using the display 140.

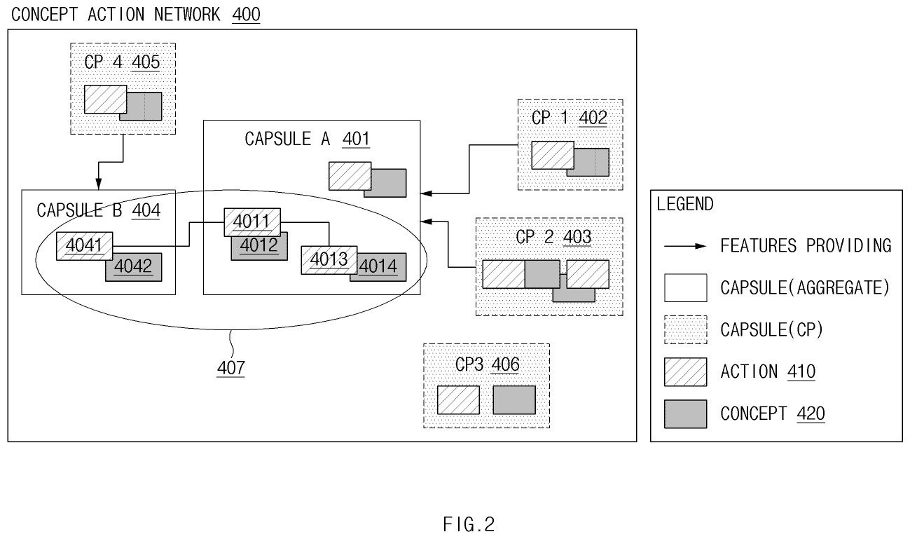

FIG. 2 is a diagram illustrating the form in which relationship information between a concept and an action is stored in a database, according to certain embodiments.

A capsule database (e.g., the capsule DB 230) of the intelligence server 200 may store a capsule in the form of a CAN. The capsule DB may store an action for processing a task corresponding to a user's voice input and a parameter utilized for the action, in the CAN form.

The capsule DB may store a plurality capsules (a capsule A 401 and a capsule B 404) respectively corresponding to a plurality of domains (e.g., applications). According to an embodiment, a single capsule (e.g., the capsule A 401) may correspond to a single domain (e.g., a location (geo) or an application). Furthermore, at least one service provider (e.g., CP 1 402 or CP 2 403) for performing a function for a domain associated with the capsule may correspond to one capsule. According to an embodiment, the single capsule may include at least one or more actions 410 and at least one or more concepts 420 for performing a specified function.

The natural language platform 220 may generate a plan for performing a task corresponding to the received voice input, using the capsule stored in a capsule database. For example, the planner module 225 of the natural language platform may generate the plan by using the capsule stored in the capsule database. For example, a plan 407 may be generated by using actions 4011 and 4013 and concepts 4012 and 4014 of the capsule A 410 and an action 4041 and a concept 4042 of the capsule B 404.

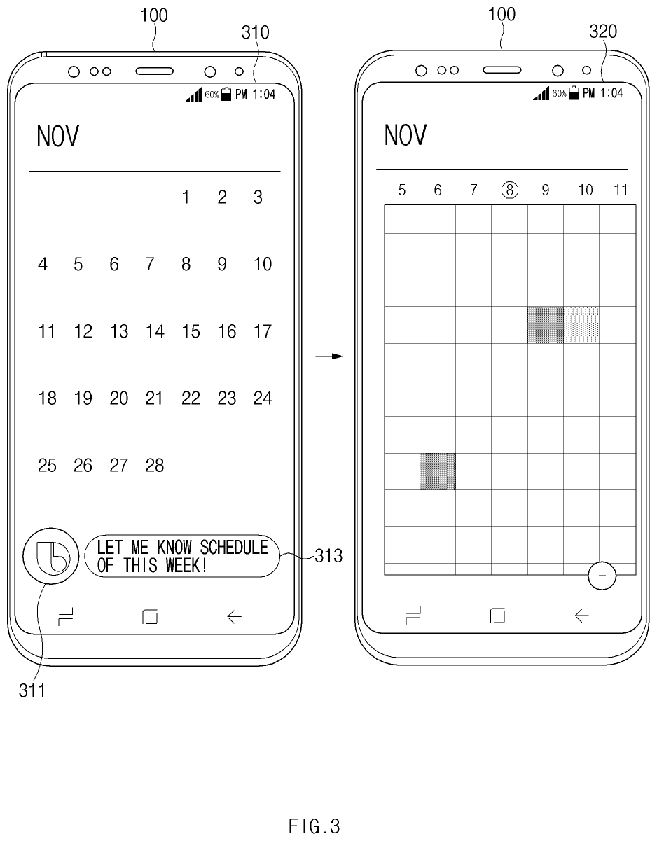

FIG. 3 is a view illustrating a screen in which a user terminal processes a voice input received through an intelligence app, according to certain embodiments.

The user terminal 100 may execute an intelligence app to process a user input through the intelligence server 200.

According to an embodiment, on screen 310, when a specified voice input (e.g., wake up!) is recognized, or when an input via a hardware key (e.g., a dedicated hardware key) is received, the user terminal 100 may launch an intelligence app for processing a voice input. For example, the user terminal 100 may launch the intelligence app in a state in which a schedule app is being executed and active in the foreground. According to an embodiment, the user terminal 100 may display an object (e.g., an icon) 311 corresponding to the intelligence app, on the display 140. According to an embodiment, the user terminal 100 may receive a voice input by a user utterance. For example, the user terminal 100 may receive a voice input uttering, “Let me know the schedule of this week!”. According to an embodiment, the user terminal 100 may display a user interface (UI) 313 (e.g., an input window) of the intelligence app, in which text data of the received voice input is displayed on the display.

According to an embodiment, on screen 320, the user terminal 100 may display a result corresponding to the received voice input, on the display. For example, the user terminal 100 may retrieve the plan corresponding to the received user input and may display ‘the schedule of this week’ on the display depending on the plan.

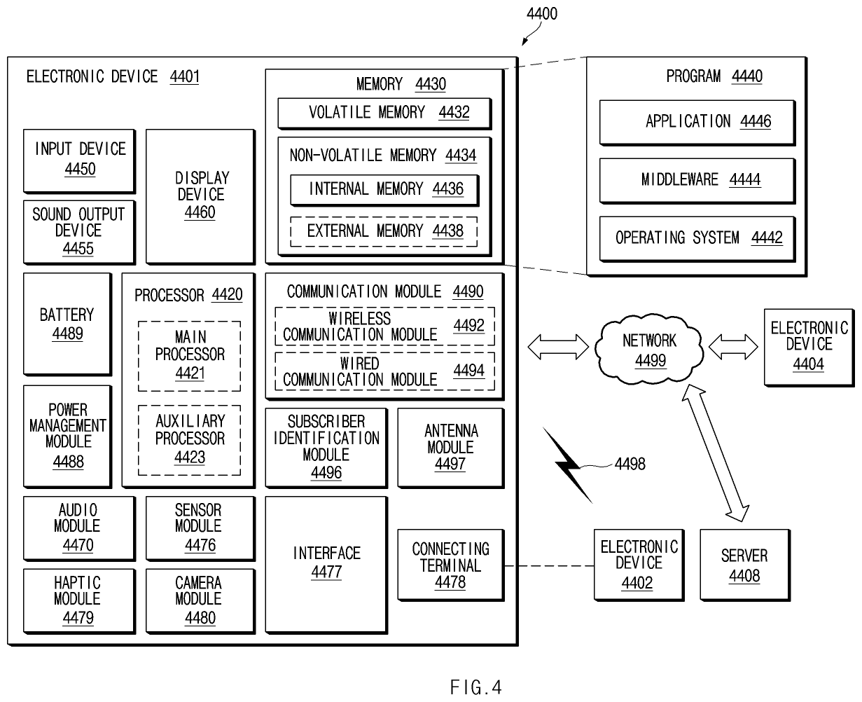

FIG. 4 is a block diagram illustrating an electronic device 4401 in a network environment 4400 according to certain embodiments. Referring to FIG. 4, the electronic device 4401 in the network environment 4400 may communicate with an electronic device 4402 via a first network 4498 (e.g., a short-range wireless communication network), or an electronic device 4404 or a server 4408 via a second network 4499 (e.g., a long-range wireless communication network). According to an embodiment, the electronic device 4401 may communicate with the electronic device 4404 via the server 4408. According to an embodiment, the electronic device 4401 may include a processor 4420, memory 4430, an input device 4450(e.g., input circuitry), a sound output device 4455, a display device 4460, an audio module 4470, a sensor module 4476, an interface 4477, a haptic module 4479, a camera module 4480, a power management module 4488, a battery 4489, a communication module 4490, a subscriber identification module (SIM) 4496, or an antenna module 4497. In some embodiments, at least one (e.g., the display device 4460 or the camera module 4480) of the components may be omitted from the electronic device 4401, or one or more other components may be added in the electronic device 4401. In some embodiments, some of the components may be implemented as single integrated circuitry. For example, the sensor module 4476 (e.g., a fingerprint sensor, an iris sensor, or an illuminance sensor) may be implemented as embedded in the display device 4460 (e.g., a display).

The processor 4420 may execute, for example, software (e.g., a program 4440) to control at least one other component (e.g., a hardware or software component) of the electronic device 4401 coupled with the processor 4420, and may perform various data processing or computation. According to one embodiment, as at least part of the data processing or computation, the processor 4420 may load a command or data received from another component (e.g., the sensor module 4476 or the communication module 4490) in volatile memory 4432, process the command or the data stored in the volatile memory 4432, and store resulting data in non-volatile memory 4434. According to an embodiment, the processor 4420 may include a main processor 4421 (e.g., a central processing unit (CPU) or an application processor (AP)), and an auxiliary processor 4423 (e.g., a graphics processing unit (GPU), an image signal processor (ISP), a sensor hub processor, or a communication processor (CP)) that is operable independently from, or in conjunction with, the main processor 4421. Additionally or alternatively, the auxiliary processor 4423 may be adapted to consume less power than the main processor 4421, or to be specific to a specified function. The auxiliary processor 4423 may be implemented as separate from, or as part of the main processor 4421.

The auxiliary processor 4423 may control at least some of functions or states related to at least one component (e.g., the display device 4460, the sensor module 4476, or the communication module 4490) among the components of the electronic device 4401, instead of the main processor 4421 while the main processor 4421 is in an inactive (e.g., sleep) state, or together with the main processor 4421 while the main processor 4421 is in an active state (e.g., executing an application). According to an embodiment, the auxiliary processor 4423 (e.g., an image signal processor or a communication processor) may be implemented as part of another component (e.g., the camera module 4480 or the communication module 4490) functionally related to the auxiliary processor 4423.

The memory 4430 may store various data used by at least one component (e.g., the processor 4420 or the sensor module 4476) of the electronic device 4401. The various data may include, for example, software (e.g., the program 4440) and input data or output data for a command related thereto. The memory 4430 may include the volatile memory 4432 or the non-volatile memory 4434.

The program 4440may be stored in the memory 4430 as software, and may include, for example, an operating system (OS) 4442, middleware 4444, or an application 4446.

The input device 4450 may receive a command or data to be used by other component (e.g., the processor 4420) of the electronic device 4401, from the outside (e.g., a user) of the electronic device 4401. The input device 4450 may include, for example, a microphone, a mouse, a keyboard, or a digital pen (e.g., a stylus pen).

The sound output device 4455 may output sound signals to the outside of the electronic device 4401. The sound output device 4455 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 4460 may visually provide information to the outside (e.g., a user) of the electronic device 4401. The display device 4460 may include, for example, a display, a hologram device, or a projector and control circuitry to control a corresponding one of the display, hologram device, and projector. According to an embodiment, the display device 4460 may include touch circuitry adapted to detect a touch, or sensor circuitry (e.g., a pressure sensor) adapted to measure the intensity of force incurred by the touch.

The audio module 4470 may convert a sound into an electrical signal and vice versa. According to an embodiment, the audio module 4470 may obtain the sound via the input device 4450, or output the sound via the sound output device 4455 or a headphone of an external electronic device (e.g., an electronic device 4402) directly (e.g., wiredly) or wirelessly coupled with the electronic device 4401.

The sensor module 4476 may detect an operational state (e.g., power or temperature) of the electronic device 4401 or an environmental state (e.g., a state of a user) external to the electronic device 4401, and then generate an electrical signal or data value corresponding to the detected state. According to an embodiment, the sensor module 4476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 4477 may support one or more specified protocols to be used for the electronic device 4401 to be coupled with the external electronic device (e.g., the electronic device 4402) directly (e.g., wiredly) or wirelessly. According to an embodiment, the interface 4477 may include, for example, a high definition multimedia interface (HDMI), a universal serial bus (USB) interface, a secure digital (SD) card interface, or an audio interface.

A connecting terminal 4478 may include a connector via which the electronic device 4401 may be physically connected with the external electronic device (e.g., the electronic device 4402). According to an embodiment, the connecting terminal 4478 may include, for example, a HDMI connector, a USB connector, a SD card connector, or an audio connector (e.g., a headphone connector).

The haptic module 4479 may convert an electrical signal into a mechanical stimulus (e.g., a vibration or a movement) or electrical stimulus which may be recognized by a user via his tactile sensation or kinesthetic sensation. According to an embodiment, the haptic module 4479 may include, for example, a motor, a piezoelectric element, or an electric stimulator.

The camera module 4480 may capture a still image or moving images. According to an embodiment, the camera module 4480 may include one or more lenses, image sensors, image signal processors, or flashes.

The power management module 4488 may manage power supplied to the electronic device 4401. According to an embodiment, the power management module 4488 may be implemented as at least part of, for example, a power management integrated circuit (PMIC).

The battery 4489 may supply power to at least one component of the electronic device 4401. According to an embodiment, the battery 4489 may include, for example, a primary cell which is not rechargeable, a secondary cell which is rechargeable, or a fuel cell.

The communication module 4490 may support establishing a direct (e.g., wired) communication channel or a wireless communication channel between the electronic device 4401 and the external electronic device (e.g., the electronic device 4402, the electronic device 4404, or the server 4408) and performing communication via the established communication channel. The communication module 4490 may include one or more communication processors that are operable independently from the processor 4420 (e.g., the application processor (AP)) and supports a direct (e.g., wired) communication or a wireless communication. According to an embodiment, the communication module 4490 may include a wireless communication module 4492 (e.g., a cellular communication module, a short-range wireless communication module, or a global navigation satellite system (GNSS) communication module) or a wired communication module 4494 (e.g., a local area network (LAN) communication module or a power line communication (PLC) module). A corresponding one of these communication modules may communicate with the external electronic device via the first network 4498 (e.g., a short-range communication network, such as Bluetooth™ wireless-fidelity (Wi-Fi) direct, or infrared data association (IrDA)) or the second network 4499 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 4492 may identify and authenticate the electronic device 4401 in a communication network, such as the first network 4498 or the second network 4499, using subscriber information (e.g., international mobile subscriber identity (IMSI)) stored in the subscriber identification module 4496.

The antenna module 4497 may transmit or receive a signal or power to or from the outside (e.g., the external electronic device) of the electronic device 4401. According to an embodiment, the antenna module 4497 may include an antenna including a radiating element implemented using a conductive material or a conductive pattern formed in or on a substrate (e.g., PCB). According to an embodiment, the antenna module 4497 may include a plurality of antennas. In such a case, at least one antenna appropriate for a communication scheme used in the communication network, such as the first network 4498 or the second network 4499, may be selected, for example, by the communication module 4490 (e.g., the wireless communication module 4492) from the plurality of antennas. The signal or the power may then be transmitted or received between the communication module 4490 and the external electronic device via the selected at least one antenna. According to an embodiment, another component (e.g., a radio frequency integrated circuit (RFIC)) other than the radiating element may be additionally formed as part of the antenna module 4497.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 4401 and the external electronic device 4404 via the server 4408 coupled with the second network 4499. Each of the electronic devices 4402 and 4404 may be a device of a same type as, or a different type, from the electronic device 4401. According to an embodiment, all or some of operations to be executed at the electronic device 4401 may be executed at one or more of the external electronic devices 4402, 4404, or 4408. For example, if the electronic device 4401 should perform a function or a service automatically, or in response to a request from a user or another device, the electronic device 4401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 4401. The electronic device 4401 may provide the outcome, with or without further processing of the outcome, as at least part of a reply to the request. To that end, a cloud computing, distributed computing, or client-server computing technology may be used, for example.

The user terminal 100 of FIGS. 1, 2, and 3 may correspond to the electronic device 4401. In an embodiment, the intelligence server 200 of FIG. 1 may correspond to one of the electronic device 4404 and the server 4408. In an embodiment, the processor 160 of FIG. 1 may correspond to the processor 4420; the display 140 of FIG. 1 may correspond to the display device 4460; and, the speaker 130 of FIG. 1 may correspond to the sound output device 4455.

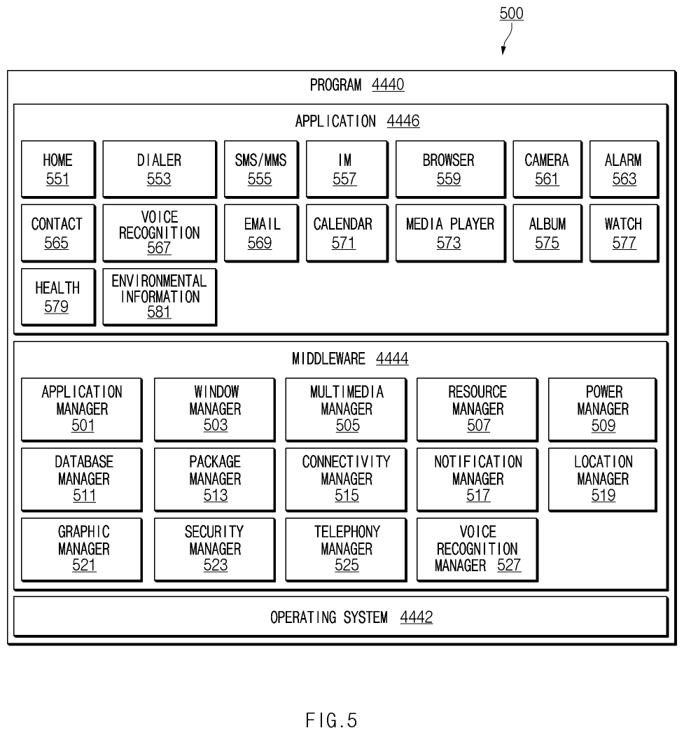

FIG. 5 is a block diagram 500 illustrating the program 4440 according to certain embodiments. According to an embodiment, the program 4440 may include an operating system (OS) 4442 to control one or more resources of the electronic device 4401, middleware 4444, or an application 4446 executable in the OS 4442. The OS 4442 may include, for example, Android™, iOS™, Windows™, Symbian™, Tizen™, or Bada™. At least part of the program 4440, for example, may be pre-loaded on the electronic device 4401 during manufacture, or may be downloaded from or updated by an external electronic device (e.g., the electronic device 4402 or 4404, or the server 4408) during use by a user.

The OS 4442 may control management (e.g., allocating or deallocation) of one or more system resources (e.g., process, memory, or power source) of the electronic device 4401. The OS 4442, additionally or alternatively, may include one or more driver programs to drive other hardware devices of the electronic device 4401, for example, the input device 4450, the sound output device 4455, the display device 4460, the audio module 4470, the sensor module 4476, the interface 4477, the haptic module 4479, the camera module 4480, the power management module 4488, the battery 4489, the communication module 4490, the subscriber identification module 4496, or the antenna module 4497.

The middleware 4444 may provide various functions to the application 4446 such that a function or information provided from one or more resources of the electronic device 4401 may be used by the application 4446. The middleware 4444 may include, for example, an application manager 501, a window manager 503, a multimedia manager 505, a resource manager 507, a power manager 509, a database manager 511, a package manager 513, a connectivity manager 515, a notification manager 517, a location manager 519, a graphic manager 521, a security manager 523, a telephony manager 525, or a voice recognition manager 527.

The application manager 501, for example, may manage the life cycle of the application 4446. The window manager 503, for example, may manage one or more graphical user interface (GUI) resources that are used on a screen. The multimedia manager 505, for example, may identify one or more formats to be used to play media files, and may encode or decode a corresponding one of the media files using a codec appropriate for a corresponding format selected from the one or more formats. The resource manager 507, for example, may manage the source code of the application 4446 or a memory space of the memory 4430.The power manager 509, for example, may manage the capacity, temperature, or power of the battery 4489, and determine or provide related information to be used for the operation of the electronic device 4401 based at least in part on corresponding information of the capacity, temperature, or power of the battery 4489. According to an embodiment, the power manager 509 may interwork with a basic input/output system (BIOS) (not shown) of the electronic device 4401.

The database manager 511, for example, may generate, search, or change a database to be used by the application 4446. The package manager 513, for example, may manage installation or update of an application that is distributed in the form of a package file. The connectivity manager 515, for example, may manage a wireless connection or a direct connection between the electronic device 4401 and the external electronic device. The notification manager 517, for example, may provide a function to notify a user of an occurrence of a specified event (e.g., an incoming call, message, or alert). The location manager 519, for example, may manage locational information on the electronic device 4401. The graphic manager 521, for example, may manage one or more graphic effects to be offered to a user or a user interface related to the one or more graphic effects.

The security manager 523, for example, may provide system security or user authentication. The telephony manager 525, for example, may manage a voice call function or a video call function provided by the electronic device 4401. The voice recognition manager 527, for example, may transmit a user's voice data to the server 4408, and receive, from the server 4408, a command corresponding to a function to be executed on the electronic device 4401 based at least in part on the voice data, or text data converted based at least in part on the voice data. According to an embodiment, the middleware 544 may dynamically delete some existing components or add new components. According to an embodiment, at least part of the middleware 4444 may be included as part of the OS 4442 or may be implemented as another software separate from the OS 4442.

The application 4446 may include, for example, a home 551, dialer 553, short message service (SMS)/multimedia messaging service (MMS) 555, instant message (IM) 557, browser 559, camera 561, alarm 563, contact 565, voice recognition 567, email 569, calendar 571, media player 573, album 575, watch 577, health 579 (e.g., for measuring the degree of workout or biometric information, such as blood sugar), or environmental information 581 (e.g., for measuring air pressure, humidity, or temperature information) application. According to an embodiment, the application 4446 may further include an information exchanging application (not shown) that is capable of supporting information exchange between the electronic device 4401 and the external electronic device. The information exchange application, for example, may include a notification relay application adapted to transfer designated information (e.g., a call, message, or alert) to the external electronic device or a device management application adapted to manage the external electronic device. The notification relay application may transfer notification information corresponding to an occurrence of a specified event (e.g., receipt of an email) at another application (e.g., the email application 569) of the electronic device 4401 to the external electronic device. Additionally or alternatively, the notification relay application may receive notification information from the external electronic device and provide the notification information to a user of the electronic device 4401.

The device management application may control the power (e.g., turn-on or turn-off) or the function (e.g., adjustment of brightness, resolution, or focus) of the external electronic device or some component thereof (e.g., a display device or a camera module of the external electronic device). The device management application, additionally or alternatively, may support installation, delete, or update of an application running on the external electronic device.

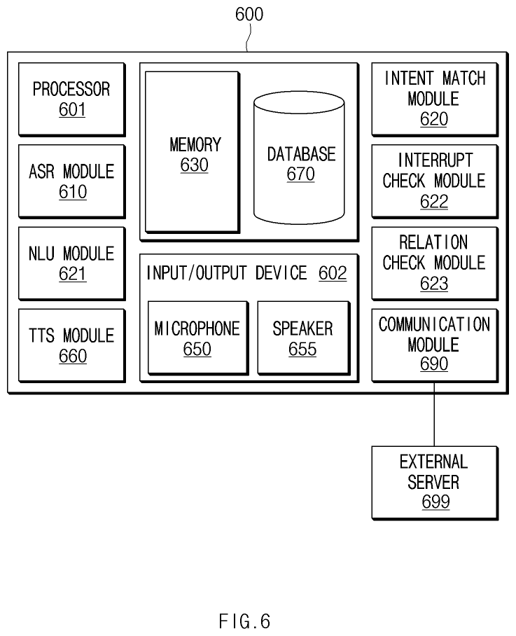

FIG. 6 is a block diagram illustrating a structure of an electronic device 600, according to an embodiment disclosed in the specification. For clarity of description, descriptions the same as the above-mentioned descriptions may be briefly described or omitted.

Referring to FIG. 6, the electronic device 600 (e.g., the user terminal 100 of FIG. 1 and/or the electronic device 4401 of FIG. 4) may include a processor 601 (e.g., the processor 160 of FIG. 1 and/or the processor 4420 of FIG. 4), a memory 630 (e.g., the memory 4430 of FIG. 4), a database 670, a input/output device 602, and a communication module 690 (e.g., the communication module 4490 of FIG. 4). The input/output device may include a microphone 650 (e.g., the microphone 120 of FIG. 1 and/or the input device 4450 of FIG. 4) and a speaker 655 (e.g., the speaker 130 and/or the sound output device 4455 of FIG. 4).

Moreover, the electronic device 600 may include an ASR module 610 (e.g., the ASR module 221 of FIG. 1), an NLU module 621 (e.g., the NLU module 223 of FIG. 1), a TTS module 660 (e.g., the TTS module 229 of FIG. 1), an intent match module 620, an interrupt check module 622, and a relation check module 623.

The electronic device 600 may further include at least one of additional components in addition to the components illustrated in FIG. 6. According to an embodiment, the components of the electronic device 600 may be the same entities or may be implemented using separate entities.

For example, the electronic device 600 may include a smartphone, a tablet PC, a wearable device, a home appliance, or a digital camera.

According to an embodiment, the processor 601 may be operatively coupled to the communication module 690, the memory 630, and the input/output device (the microphone 650 and the speaker 655) to perform overall functions of the electronic device 600. For example, the processor 601 may include one or more processors. For example, the one or more processors may include an image signal processor (ISP), an application processor (AP), or a communication processor (CP).

The processor 601 may drive the ASR module 610, the NLU module 621, the intent match module 620, the interrupt check module 622, the relation check module 623, and the TTS module 660 by executing the instructions stored in the memory 630.

To perform overall functions of the electronic device 600, the processor 601 may be operatively connected to the ASR module 610, the NLU module 621, the intent match module 620, the interrupt check module 622, the relation check module 623, and the TTS module 660. In the embodiment disclosed in this specification, it may be understood that the operation performed (or executed) by the ASR module 610, the NLU module 621, the intent match module 620, the interrupt check module 622, the relation check module 623, and the TTS module 660 is an operation performed by the processor 601 executing instructions stored in the memory 630.

Several modules described in certain embodiments of the disclosure may be implemented by hardware or software.

The memory 630 may store the database 670 including at least one input data. The memory 630 may store commands, information, or data associated with operations of components included in the electronic device 600. For example, the memory 630 may store instructions, when executed, that cause the processor 601 to perform various operations described in the specification.

In an embodiment, unlike the illustration of FIG. 6, the processor 601 may include the ASR module 610, the NLU module 621, the intent match module 620, the interrupt check module 622, the relation check module 623, and the TTS module 660. In this case, the operation performed (or executed) by each of the ASR module 610, the NLU module 621, the intent match module 620, the interrupt check module 622, the relation check module 623, and the TTS module 660 may be implemented as at least part of the processor 601.

In an embodiment, the electronic device 600 may receive a user input by using a input device. The user input may be an input for setting a new shortcut command or an input for adding a function to be included in a configuration of a predetermined shortcut command.

In an embodiment, the user input may be the user's voice input (e.g., an utterance). When the user input is a voice input, the electronic device 600 may receive a user input through the microphone 650.

In an embodiment, the user input may be the user's text input. When the user input is a text input, the electronic device 600 may receive a user input through an input device (e.g., the input device 4450 of FIG. 4).

The ASR module 610 may convert the received user input into text data.

The intent match module 620 may receive the converted text data as input data. The intent match module 620 may identify a function (task) for executing the user input based on the input data. The intent match module 620 may deliver data about the identified function to the NLU module 621. The NLU module 621 may match intent and parameters corresponding to the function by performing grammatical analysis and/or semantic analysis on the identified function.

For example, the NLU module 621 may include a capsule network (not shown). The NLU module 621 may perform grammatical analysis and/or semantic analysis on the identified function and may identify the intent and parameters according to the function, by identifying a function to be executed in a capsule and the capsule, in which the function is executed, by using the capsule network (not shown).

The intent match module 620 may receive the intent determined by the NLU module 621 and may match the intent to the intent of the function. When the intent of the function is not determined by the NLU module 621, the intent match module 620 may determine that the function is not supported by the electronic device 600, and may classify the function as an unavailable function.

In an embodiment, when determining the intent and the parameter according to the function, the NLU module 621 may determine the accuracy together. When the accuracy is less than or equal to a threshold value although the intent according to the function is matched depending on the determined accuracy, the intent match module 620 may classify the function as an inaccurate function. As the intent match module 620 classifies the function based on the threshold value of the accuracy, the electronic device 600 may reduce the risk of executing an action that is not intended by a user.

In an embodiment, the intent match module 620 may generate a configuration (plan) for executing a user input by using the intent and parameter that are determined by the NLU module 621. According to an embodiment, the intent match module 620 may determine one or more domains utilized to perform a function (task) included in a configuration (plan) for executing the user input based on the determined intent. For example, the intent match module 620 may identify that a user desires to execute a capsule or domain supporting a chatting mode using an utterance, based on a user input. The chatting mode may be a conversational input mode. For example, the capsule or domain may be a schedule domain, a chat domain, a weather domain, a music domain, or a third party domain, but the embodiments disclosed in this specification are not limited thereto. According to an embodiment, the planner module 225 may determine one or more domains utilized to perform a function (task) included in a configuration (plan) for executing the user input based on the determined intent.

In an embodiment, a configuration for executing a user input may include a plurality of functions. When the configuration for executing a user input includes a plurality of functions, the NLU module 621 may match intent and parameters, which correspond to each function, by performing grammatical analysis and/or semantic analysis on each function one by one.

Together with information about the matched intent, the intent match module 620 may deliver a function matched to intent to the interrupt check module 622.

The interrupt check module 622 may determine whether the function is an interrupt function, by using the received function and information of intent matched to the function. The interrupt function may refer to a function that prevents the execution of the function from proceeding because the execution of the function affects a system of the electronic device 600 or changes settings. For example, the interrupt function may include a data use interrupt function, a function of turning off a screen of the electronic device 600, a function of starting a lock mode of the electronic device 600, and the like.

The interrupt check module 622 may classify a function, which is determined to be an interrupt function, as a non-executable function. In an embodiment, the interrupt check module 622 may determine whether the received function is an interrupt function, based on a list in which the intent corresponding to the interrupt function is defined. In an embodiment, the interrupt check module 622 may determine whether the received function is an interrupt function, by using an artificial neural network or a learning system similar to the artificial neural network without a list in which a separate intent is defined.

In an embodiment, the interrupt check module 622 may also determine a function, which involves interaction, as an interrupt function. The function that involves interaction may mean a function completed when the intent matched to the function passes through several steps. For example, when receiving information about the intent corresponding to the function, the interrupt check module 622 may also receive data obtained by counting steps of the function and may determine whether the function is a function that involves interaction. The function that involves the interaction may refer to a function that involves two or more steps. For example, a function determined to be a function involving two or more steps may be classified as an interaction function.

When it is determined that the received function is an interrupt function, the interrupt check module 622 may classify the received function as a non-executable function.

The relation check module 623 may classify functions, which are classified as normal functions, into a function with relation and a function without relation by identifying the relation between the functions. The normal function may mean a function capable of being normally executed by the electronic device 600. For example, the normal function may mean a function that is not classified as an unavailable function, a function that is not classified as an inaccurate function, or a function that is not classified as a non-executable function. The reason is that the electronic device 600 may remove unavailable functions, inaccurate functions, or non-executable functions when storing a shortcut command.

The relation check module 623 may sequentially check each normal function and may identify the relation with the normal function to be executed before the corresponding function. The relation check module 623 may determine whether there is data, which has been already mentioned, from among data to be used in a current normal function, by comparing the previous normal function with the current normal function. The data thus previously mentioned may mean data used for addition, change, and/or deletion of data while the previous normal function is executed.

In an embodiment, the relation check module 623 may classify the normal function, which is received for the first time, into an unrelated item. With respect to the normal function to be received, the relation check module 623 may analyze the relation by determining whether there is a function processed in the same capsule as the function before the corresponding normal function and/or whether the same parameter or the same data is used during processing even when a domain is not the same. For example, it is assumed that the normal function 1 thus currently received is a function that performs additional processing on ‘a’, and function 2 among normal functions thus previously received that deletes or changes ‘a’. The relation check module 623 may determine that function 1 is associated with function 2, and then may allow the user to determine whether the user creates a shortcut command while intending the order of function 1 and function 2. For example, as for function 3 of deleting data about ‘Gil-dong Hong’ from a contact domain and function 4 of making a call to ‘Gil-dong Hong’ in a phone domain, the relation check module 623 may determine that function 3 is associated with function 4, and then may allow the user to determine whether the user creates a shortcut command while intending the order of function 3 and function 4.

The TTS module 660 may convert the response data being in a text form into voice data. The electronic device 600 (and/or the processor 601) may output the response data converted into the voice data, through the speaker 655.

In an embodiment, at least one operation among operations of each component described with reference to the electronic device 600 may be performed (or executed) by an external server 699 or another electronic device (not illustrated). For example, the processor 601 may transmit a user input to the external server 699 or the other electronic device (not illustrated) by using the communication module 690.

A processor (not illustrated) included in the external server 699 or the other electronic device (not illustrated) may receive the user input, may generate the response data, and may transmit the response data to the electronic device 600.

The processor 601 may receive the response data corresponding to the user input from the external server 699 or the other electronic device (not illustrated) through the communication module 690. When receiving the response data, the processor 601 may allow the speaker 655 to output the response data. Alternatively, through the communication module 690, other devices may be controlled or data may be stored. The processor 601 may include at least one or more processors, and may be driven while being physically divided into a main processor performing high-performance processing and an auxiliary processor performing low-power processing. Alternatively, one processor may process data by switching between a high performance mode and a low power mode depending on situations.

Hereinafter, an operation of the processor 601 will be described in detail.

In an embodiment, an electronic device may include an input device, an output device, a processor operatively connected to the input device and the output device, and a memory operatively connected to the processor. The memory may store instructions that, when executed, cause the processor to receive a user input by using the input device, to identify a function included in a configuration for executing the user input based on input data corresponding to the user input, to classify the identified function, to determine completion possibility of the classified function, and to provide response data by using the output device based on a result of classifying the identified function and the completion probability.

In an embodiment, the determining of the completion possibility may include determining whether information about a parameter for executing the function is requested, based on the identified input data. The instructions may cause the processor to provide the response data for requesting a user input for the information by using the output device when the information about the parameter is requested.

In an embodiment, additional information about the parameter may include additional information about at least one parameter among a parameter for a domain for executing the user input based on the identified input data or a parameter utilized to execute intent of the domain.

In an embodiment, the instructions may cause the processor to identify, based on natural language processing, the function included in the configuration for executing the user input from the user input.

In an embodiment, the instructions may cause the processor to execute a capsule or a domain, which supports a chatting mode using a user utterance, based at least partly on the user input.

In an embodiment, the instructions may cause the processor to determine whether intent of a user is matched with the identified function, and to classify the identified function as an unavailable function when the intent of the user is not matched.

In an embodiment, the instructions may cause the processor to determine accuracy of the matching with respect to a function matched with the intent, and to classify the identified function as an inaccurate function when the accuracy of the matching is less than or equal to a threshold value.

In an embodiment, the instructions may cause the processor to determine whether the identified function is an interrupt function, and to classify the identified function as a non-executable function when it is determined that the identified function is the interrupt function.

In an embodiment, the instructions may cause the processor to determine whether the configuration for the user input includes at least two normal functions, and to determine whether the at least two normal functions have an interaction function relation with each other when the configuration includes the at least two normal functions.

In an embodiment, the instructions may cause the processor to provide the response data for determining whether the interaction function is intended, by using the output device when it is determined that the at least two normal functions have the interaction function relation with each other.

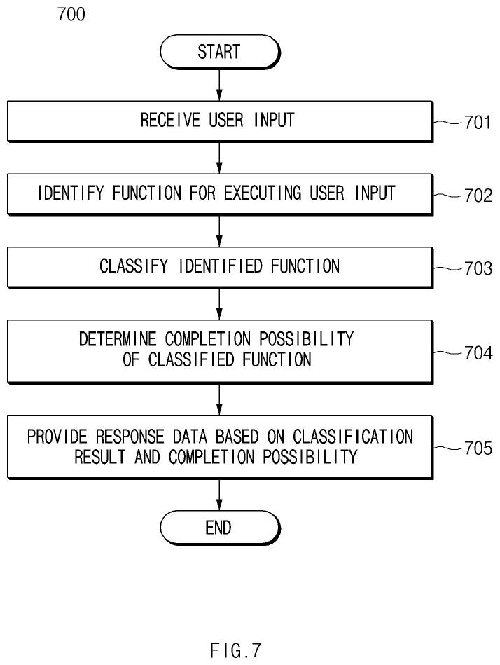

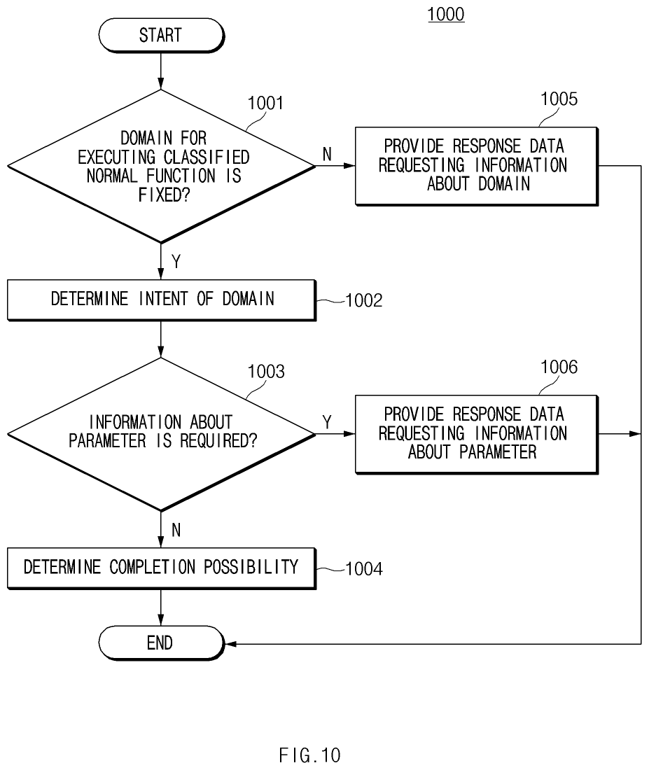

Hereinafter, a method, in which the electronic device 4401 processes a user input, according to an embodiment disclosed in the specification will be described with reference to FIGS. 7 and 10.

FIG. 7 is a flowchart 700 illustrating a method, in which the electronic device 4401 processes a user input, according to certain embodiments. According to an embodiment, it may be understood that the process illustrated in FIG. 7 is performed by a processor (e.g., the processor 4420 of FIG. 4) of an electronic device (e.g., the electronic device 4401 of FIG. 4) by executing instructions stored in a memory (e.g., the memory 4430 of FIG. 4).

In operation 701, the electronic device 4401 may receive a user input. The user input include a request to add a function to a shortcut command(e.g., a quick command, including a plurality of functions to be executed upon receiving a single user utterance). For example, the user input may be an input for adding a new function to a predetermined shortcut command. Alternatively, the user input may be an input for creating a new shortcut command, and adding a function to the new shortcut command.

The electronic device 4401 may receive the user input via a input device. The input device may include for example one or more of a microphone, and an input device.

In an embodiment, the user input may be the user's voice input (e.g., an utterance). When the user input is a voice input, the electronic device 4401 may receive a user input through the microphone.

In an embodiment, the user input may be the user's text input. When the user input is a text input, the electronic device 4401 may receive a user input through an input device, such as a software or hardware implemented keypad.

In an embodiment, the electronic device 4401 may identify input data matching with the received user input. For example, when the user input is a voice input (e.g., an utterance), the electronic device 4401 may convert the received user input into text data.

In operation 702, the electronic device 4401 may identify a function included in a configuration for executing a user input. For example, the electronic device 4401 may identify a function (e.g., a task) for executing the user input based on the identified input data. When there are a plurality of functions included in a configuration of the user input, the electronic device 4401 may identify each of the plurality of functions.

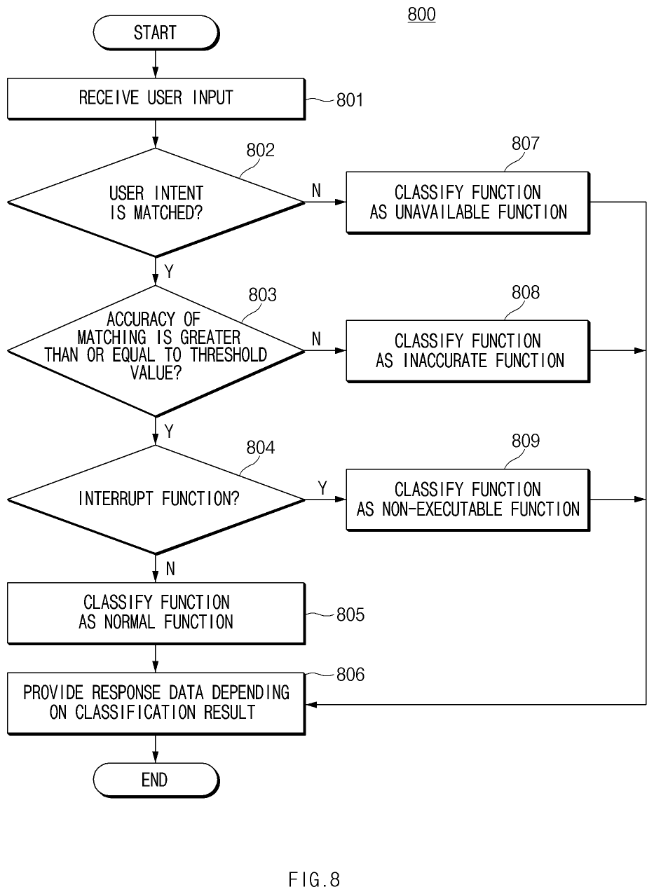

In operation 703, the electronic device 4401 may classify the identified functions. For example, the electronic device 4401 may classify the identified functions into an unavailable function, an inaccurate function, a non-executable function, and a normal function. This will be described in detail with reference to FIG. 8.

In operation 704, the electronic device 4401 may determine the completion possibility of each classified function. The completion possibility for each classified function may indicate whether the electronic device 4401 is capable of successfully executing the classified function in response to the user input.

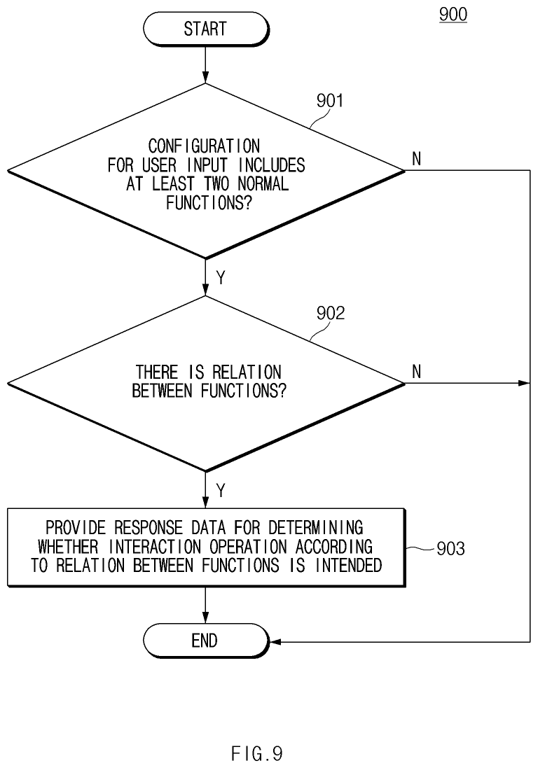

In an embodiment, the electronic device 4401 may determine the completion possibility of the classified function based on whether the relation between functions is present. This will be described in detail with reference to FIG. 9.

In an embodiment, when the function involves an input for an additional parameter, the electronic device 4401 may determine that the completion possibility of the function is low. This will be described in detail with reference to FIG. 10.

In operation 705, the electronic device 4401 may provide response data based on the classification results, and the respective completion possibilities. The response data may indicate whether the identified function has a suitable configuration for a user input. The response data may indicate a correction direction according to the classification result of each function. For example, when the identified function includes a below-threshold completion possibility, the electronic device 4401 may provide the response data requesting an additional input of a parameter for completing the function. Alternatively, when the classification result indicates the completion possibility is at or above a threshold value, the electronic device 4401 may output a list including the function in the configuration as response data.

FIG. 8 is a flowchart 800 of a method in which the electronic device 4401 classifies a function corresponding to a user input, according to certain embodiments. According to an embodiment, it may be understood that the process illustrated in FIG. 8 is performed by a processor (e.g., the processor 4420 of FIG. 4) of an electronic device (e.g., the electronic device 4401 of FIG. 4) by executing instructions stored in a memory (e.g., the memory 4430 of FIG. 4).

In operation 801, the electronic device 4401 may receive a user input. The electronic device 4401 may receive the user input via input device. The input device may include a microphone, and an input device. It has been described with reference to FIG. 7, and thus a detailed description thereof will be omitted to avoid redundancy.

In operation 802, the electronic device 4401 may determine whether the user input matches a prestored user intent. The electronic device 4401 may identify input data matched to the user input. The electronic device 4401 may identify a function for executing the user input based on the identified input data. The electronic device 4401 may match intent and parameters, which correspond to the function, by performing grammatical analysis and/or semantic analysis on the identified function by using the NLU module (e.g., the NLU module 621 of FIG. 6). When determining the intent according to the function, the electronic device 4401 may determine the accuracy together.

When the intent corresponding to the function is not identifiable, this may indicate that the function is not supported by the electronic device 4401. Accordingly, when the electronic device 4401 is incapable of responding to the user intent, then in operation 807, the electronic device 4401 may classify the function as an “unavailable.”

In contrast, when a match between the user intent and the function is positively detected, then in operation 803, the electronic device 4401 may determine whether the matching accuracy between the intent and the function is greater than or equal to a threshold value. The accuracy of matching may be based on the accuracy of the function determined in operation 802. When it is determined in operation 803 that the accuracy is less than or equal to the threshold value, in operation 808, the electronic device 4401 may classify the function as “inaccurate.” This may be performed to reduce the risk of executing an operation not intended by the user.

On the other hand, when it is determined in operation 803 that the accuracy is greater than or equal to the threshold value, in operation 804, the electronic device 4401 may determine whether the function is an interrupt function. The electronic device 4401 may determine whether the configuration of a user input is incapable of execution, because the execution of the function will impact a system of the electronic device 4401 or utilize a forbidden change in setting.

When determining that the function is an interrupt function, in operation 809, the electronic device 4401 may classify the function as “non-executable.” On the other hand, when determining that the function is not an interrupt function, in operation 805, the electronic device 4401 may classify the function as a normal function.

In operation 806, the electronic device 4401 may provide response data depending on the classification results. As the electronic device 4401 provides the response data depending on the classification result of each function, the user may determine whether each function added through the user input is a function executed by the electronic device 4401, through the response data.

FIG. 9 is a flowchart 900 illustrating a method in which the electronic device 4401 determines whether a function corresponding to a user input is an interaction function, according to certain embodiments. According to an embodiment, it may be understood that the process illustrated in FIG. 9 is performed by a processor (e.g., the processor 4420 of FIG. 4) of an electronic device (e.g., the electronic device 4401 of FIG. 4) by executing instructions stored in a memory (e.g., the memory 4430 of FIG. 4).

In operation 901, the electronic device 4401 may determine whether the configuration for a user input includes at least two “normal” functions, meaning two functions classified as normal. When the configuration for executing a user input includes a plurality of functions, the electronic device 4401 may determine whether each of functions is classified as a normal function, by performing grammatical analysis and/or semantic analysis on each of the functions one by one. Alternatively, the electronic device 4401 may determine whether each of the functions is a normal function, by using the classification result of operation 805 of FIG. 8. When it is determined that at least two functions among the plurality of functions are normal, the electronic device 4401 may determine that the configuration for a user input includes at least two normal functions.

When the configuration includes at least two normal functions, in operation 902, the electronic device 4401 may determine whether a relation exists between the two normal functions. For example, the electronic device 4401 may determine whether some subset of data to be used in a first normal function is also included among the total set of data for utilizing by the second normal function. When such data is present, the electronic device 4401 may determine the existence of a relation between the at least two normal functions.

When it is determined that the relation between the at least two functions is present, in operation 903, the electronic device 4401 may provide response data for determining whether an interaction operation according to the relation between functions is intended. For example, when the current function (e.g., function 3) is a function that performs additional processing on ‘a’ and another function (e.g., function 4) included in the configuration is a function that deletes or changes ‘a’, the electronic device 4401 may determine that function 3 and function 4 are interaction functions having a relationship, and may provide the user with the response data for determining whether the order of function 3 and function 4 is intentionally created. For example, the electronic device 4401 may output, as part of the response data, a prompt querying confirmation that the interaction is intended.

FIG. 10 is a flowchart 1000 illustrating a method in which the electronic device 4401 determines the completion possibility of a function corresponding to a user input, according to certain embodiments. According to an embodiment, it may be understood that the process illustrated in FIG. 10 is performed by a processor (e.g., the processor 4420 of FIG. 4) of an electronic device (e.g., the electronic device 4401 of FIG. 4) by executing instructions stored in a memory (e.g., the memory 4430 of FIG. 4).

In operation 1001, the electronic device 4401 may determine whether the domain for executing the classified normal function is fixed. Fixing the domain may mean determining that one domain is utilized for the electronic device 4401 to perform a function included in a configuration executed upon reception of the associated user input.

When the electronic device 4401 is capable of fixing the domain, in operation 1002, the electronic device 4401 may determine the intent of the domain. On the other hand, when the electronic device 4401 is incapable of fixing the domain, in operation 1005, the electronic device 4401 may provide response data requesting information about a domain. For example, when there are one or more domains capable of performing the function, the electronic device 4401 may provide the response data for receiving an additional input from the user as to which domain among the one or more domains is to be fixed.

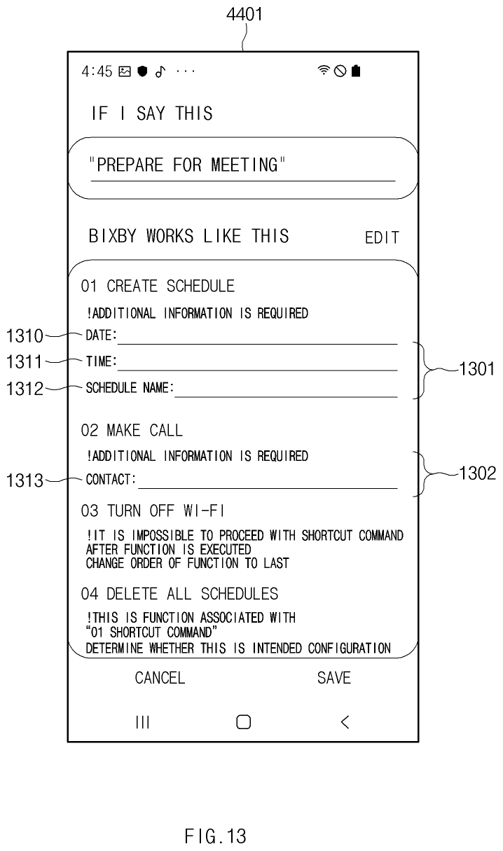

In operation 1003, the electronic device 4401 may determine whether information on a parameter should be requested for executing the intent of the determined domain. When the information about the parameter is insufficient, in operation 1006, the electronic device 4401 may provide response data requesting information about the parameter. This will be described in detail with reference to FIG. 13.

On the other hand, when there is no need for the information about the parameter, in operation 1004, the electronic device 4401 may determine the completion possibility of the normal function.

In an embodiment, a method performed by an electronic device may include receiving a user input by using an input device included in the electronic device when instructions stored in a memory included in the electronic device or operatively connected to the electronic device are executed, identifying a function included in a configuration for executing the user input based on input data matched with the user input, classifying the identified function, determining completion possibility of the classified function, and providing response data by using the output device based on a result of classifying the identified function and the completion probability.

In an embodiment, the determining of the completion possibility may include determining whether information about a parameter for executing the function is requested, based on the identified input data.

In an embodiment, the providing of the response data may include providing the response data for requesting a user input for the information by using the output device when the information about the parameter is requested.

In an embodiment, additional information about the parameter may include additional information about at least one parameter among a parameter for a domain for executing the user input based on the identified input data or a parameter utilized to execute intent of the domain.

In an embodiment, the method performed by the electronic device may further include identifying, based on natural language processing, the function included in the configuration for executing the user input from the user input.

In an embodiment, the method performed by the electronic device may further include executing a capsule or a domain, which supports a chatting mode using a user utterance, based at least partly on the user input.

In an embodiment, the method performed by the electronic device may further include determining whether intent of a user is matched with the identified function, and classifying the identified function as an unavailable function when the intent of the user is not matched.

In an embodiment, the method performed by the electronic device may further include determining accuracy of the matching with respect to a function matched with the intent, and classifying the identified function as an inaccurate function when the accuracy of the matching is less than or equal to a threshold value.

In an embodiment, the method performed by the electronic device may further include determining whether the identified function is an interrupt function, and classifying the identified function as a non-executable function when it is determined that the identified function is the interrupt function.

In an embodiment, the method performed by the electronic device may further include determining whether a configuration for the user input includes at least two normal functions, and determining whether the at least two normal functions have an interaction function relation with each other when the configuration includes the at least two normal functions.

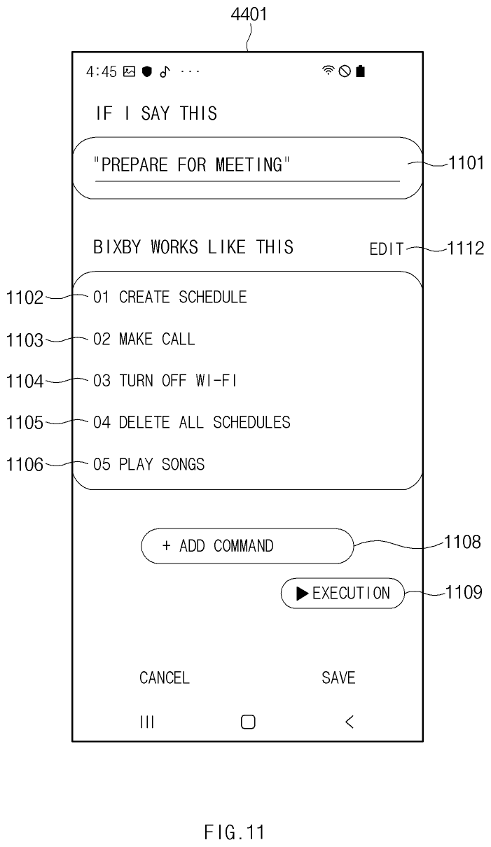

Hereinafter, a method, in which the electronic device 4401 according to an embodiment processes a user input, will be described in detail with reference to example diagrams illustrated in FIGS. 11 to 14. FIGS. 11 to 14 are example diagrams illustrating a method, in which an electronic device creates a shortcut command based on a user input, according to an embodiment of the disclosure.

FIG. 11 is an example diagram of a configuration of a shortcut command created depending on a user input.

The electronic device 4401 may receive a shortcut command through a user input. The electronic device 4401 may also receive a configuration for executing the received shortcut command through a user input. The configuration for executing the shortcut command may be a command for executing an independent function. For example, the configuration may include several sub-commands to execute the shortcut command.

Referring to FIG. 11, FIG. 11 illustrates a shortcut command (e.g., a quick command) 1101 and sub-commands (e.g., functions set for automatic execution, as included in the shortcut command) 1102, 1103, 1104, 1105, and 1106 that have been generated to execute the shortcut command 1101 created by a user. In detail, “prepare for a meeting” is shown as the shortcut command 1101, and the sub-commands include “create a schedule” 1102, “make a call” 1103, “turn off Wi-Fi” 1104, “delete all schedules” 1105, and “play songs” 1106.

Each of the sub-commands of FIG. 11 are independent functions in the electronic device 4401. For example, “create a schedule” 1102 may be a command for executing a function of creating a schedule by using a schedule management capsule of the electronic device 4401. “Make a call” 1103 may be a command for executing a function of making a call to a specific person by using the call management capsule of the electronic device 4401.

When the electronic device 4401 receives a user input to an edit icon 1112, the electronic device 4401 may display a screen for editing the configuration, allowing for example addition or removal of functions from the quick command. When receiving a user input to the icon 1108 for adding a command, the electronic device 4401 may display a screen for adding a function to the configuration. When receiving a user input to an execution icon 1109, the electronic device 4401 may determine whether the commands 1102, 1103, 1104, 1105, and 1106 included in the configuration are suitable for executing the shortcut command 1101 (e.g., as per FIG. 8), and may provide response data indicating results of the analysis.

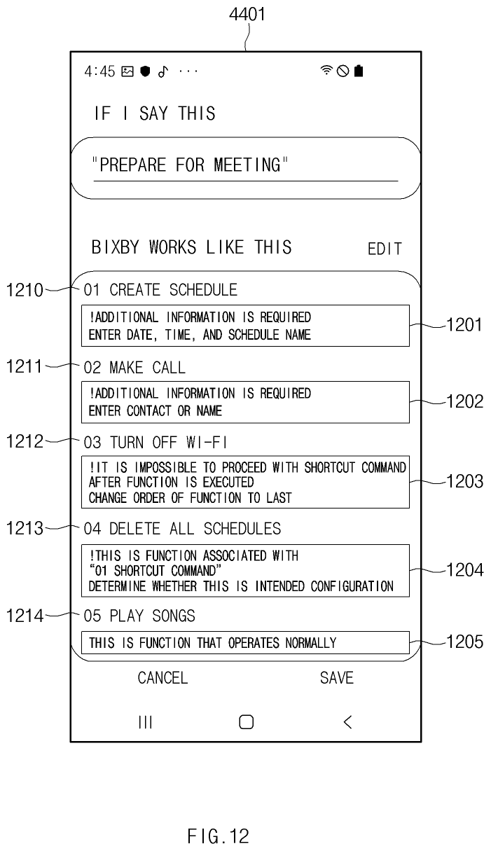

FIG. 12 is an example diagram of response data provided by the electronic device 4401 to a user.

The electronic device 4401 may provide response data after determining whether a command included in a configuration is suitable for executing a shortcut command.

According to an embodiment, the electronic device 4401 may provide the response data based on the classification result and completion possibility of functions corresponding to each command.

As for a function corresponding to “create a schedule” 1210, the electronic device 4401 may determine that additional parameters should be provided for execution. Together with content indicating that additional information about “create a schedule” 1210 is requested, the electronic device 4401 may provide response data 1201 prompting a user to further enter information about parameters of a date, a time, and a schedule name.

As for a function corresponding to “make a call” 1211, the electronic device 4401 may determine that additional parameters should be requested. Together with content indicating that additional information about “make a call” 1211 is requested, the electronic device 4401 may provide response data 1202 prompting a user to further enter information about parameters of a contact or a name.

Because a function corresponding to “turn off Wi-Fi” 1212 is an interrupt function that involves changing the settings of the electronic device 4401, the electronic device 4401 may classify the function corresponding to “turn off Wi-Fi” 1212 as a non-executable function. As “turn off Wi-Fi” 1212 is an interrupt function, it is impossible to proceed with a shortcut command after the function is executed. Accordingly, the electronic device 4401 may provide response data 1203 prompting a user to change the execution order of the function, such as moving it to a last place in the execution order, or removing it entirely.

The electronic device 4401 may determine that a function corresponding to “delete all schedules” 1213 is associated with a function corresponding to “create a schedule” 1210 that is the previous function. The electronic device 4401 may provide response data 1204 for determining whether the function corresponding to “delete all schedules” 1213 is related to the function corresponding to “create a schedule” 1210. That is, the user may be prompted to confirm whether the interaction between the two functions is intended.

The electronic device 4401 may determine that a function corresponding to “play songs” 1214 is an executable normal function and there is no need to enter an additional parameter. The electronic device 4401 may provide response data 1205 indicating that this is a function that will operate normally upon execution.

FIG. 13 is an example view of a screen provided by the electronic device 4401 to receive additional information about a parameter.

In FIG. 12, when the electronic device 4401 receives an input for response data 1201 and 1202 indicating that additional information is requested, the electronic device 4401 may display response data 1301 and 1302 for entering information about each of parameters 1310, 1311, 1312, and 1313 of FIG. 13. The electronic device 4401 may receive an additional input of a user for each of the parameters 1310, 1311, 1312, and 1313. The user's additional input may be by an utterance or text.

FIG. 13 shows a screen after the reception of all inputs for the two response data 1201 and 1202, indicating that additional information of FIG. 12 is requested, but this is only an example for illustrative purposes. An embodiment is not limited thereto. For example, the electronic device 4401 may receive an input for the response data 1201 of a function corresponding to “create a schedule” 1210 and may display response data 1301 for entering a date 1310, a time 1311, and a schedule name 1312, which are information of parameters utilized to execute a function corresponding to the received “create a schedule” 1210.

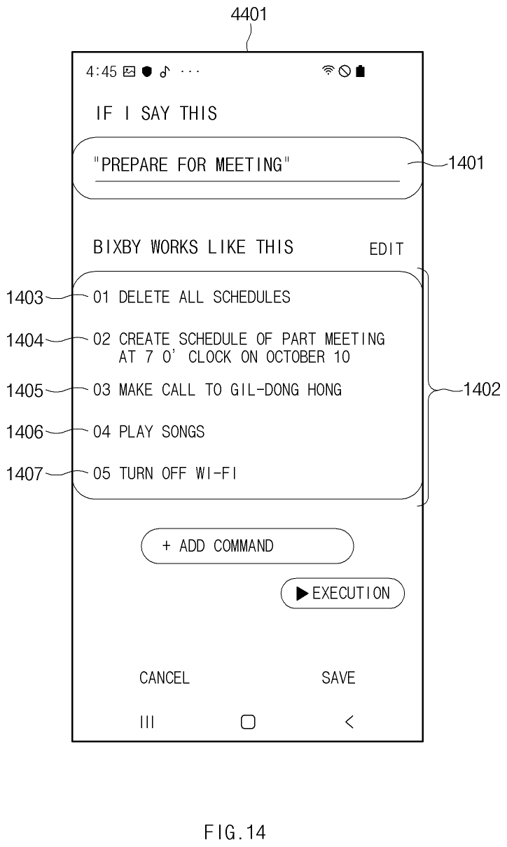

FIG. 14 is an example diagram of an altered configuration provided by the electronic device 4401 by reflecting an input for response data of a user.

In FIG. 13, when a user's input for response data is received, the electronic device 4401 may provide an altered configuration by reflecting the received user input. For example, the electronic device 4401 may reflect a user input for correcting the order of commands or a user input for additionally entering parameter information to the altered configuration. When reflecting a user input for additionally entering parameter information, the electronic device 4401 may change an existing command (e.g., “make a call”) to a command (e.g., “make a call to Gil-dong Hong”) including the parameter information thus additionally entered, and may include the changed command in the altered configuration.

For example, as illustrated in FIG. 14, the electronic device 4401 may provide an altered configuration 1402 by reflecting an input for response data of a user to the shortcut command of “prepare for a meeting” 1401. In detail, to execute “prepare for a meeting” 1401, the electronic device 4401 may provide a configuration 1402 altered as commands of “delete all schedules” 1403, “create a schedule of a part meeting at 7 o'clock on October 10” 1404, “make a call to Gil-dong Hong” 1405, “play songs” 1406, “turn off Wi-Fi” 1407.

The electronic device 4401 according to certain embodiments may be one of various types of electronic devices. The electronic device 4401 may include, for example, a portable communication device (e.g., a smartphone), a computer device, a portable multimedia device, a portable medical device, a camera, a wearable device, or a home appliance. According to an embodiment of the disclosure, the electronic device 4401 is not limited to those described above.

It should be appreciated that certain embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C” may include any one of, or all possible combinations of the items enumerated together in a corresponding one of the phrases. As used herein, such terms as “1st” and “2nd”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic”, “logic block”, “part”, or “circuitry”. A module may be a single integral component, or a minimum unit or part thereof, adapted to perform one or more functions. For example, according to an embodiment, the module may be implemented in a form of an application-specific integrated circuit (ASIC).

Certain embodiments as set forth herein may be implemented as software (e.g., the program4440) including one or more instructions that are stored in a storage medium (e.g., internal memory 4436 or external memory 4438) that is readable by a machine (e.g., the electronic device 4401, 100). For example, a processor(e.g., the processor 4420) of the machine (e.g., the electronic device 4401, 100) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to certain embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to certain embodiments, each component (e.g., a module or a program) of the above-described components may include a single entity or multiple entities. According to certain embodiments, one or more of the above-described components may be omitted, or one or more other components may be added. Alternatively or additionally, a plurality of components (e.g., modules or programs) may be integrated into a single component. In such a case, according to certain embodiments, the integrated component may still perform one or more functions of each of the plurality of components in the same or similar manner as they are performed by a corresponding one of the plurality of components before the integration. According to certain embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device, comprising:
an input device;
an output device;
a processor operatively connected to the input device and the output device; and
a memory operatively connected to the processor,
wherein the memory stores instructions that are executable by the processor to cause the electronic device to:
receive a user input via the input device;
identify a function for executing the user input, based at least on input data corresponding to the user input;
classify the identified function based on executability of the function;
determine a completion possibility of the classified function; and
provide response data via the output device based on a result of the classifying and the completion probability.

2. The electronic device of claim 1, wherein determining the completion possibility further includes:
determining whether input of a parameter for executing the function is required, based on the input data, and
wherein the providing the response data further includes:
when the input of the parameter is required, outputting a prompt requesting input of the parameter.

3. The electronic device of claim 2, wherein the parameter is for at least one of a domain for executing the user input, or for executing an intent of the domain.

4. The electronic device of claim 1, wherein the function for executing the user input is identified using natural language processing on the user input.

5. The electronic device of claim 1, wherein the instructions further cause the electronic device to:
execute a capsule or a domain that supports a conversational input mode, based at least in part on the user input.

6. The electronic device of claim 1, wherein the instructions further cause the electronic device to:
detect an intent of a user based on the user input;
determine whether the detected intent of the user matches the identified function; and
when the detected intent fails to match the identified function, classify the identified function as an unavailable function.

7. The electronic device of claim 6, wherein the instructions further cause the electronic device to:
for the identified function that matches the detected intent, determine an accuracy value of the match with the detected intent; and
when the accuracy of the match is less than or equal to a threshold value, classify the identified function as an inaccurate function.

8. The electronic device of claim 7, wherein the instructions further cause the electronic device to:
determine whether the identified function is an interrupt function; and
when determining that the identified function is the interrupt function, classify the identified function as a non-executable function.

9. The electronic device of claim 8, wherein the instructions further cause the electronic device to:
classify any remaining function as a normal function that is not classified as the unavailable function, the inaccurate function and the non-executable function;
determine whether there are at least two functions classified as normal functions; and
when the at least two functions are classified as normal functions, determine whether the at least two functions include an interaction with each other.

10. The electronic device of claim 9,
wherein when determining that the at least two functions include the interaction with each other, providing the response data includes outputting a prompt querying confirmation that the interaction is intended.

11. A method performed by an electronic device, the method comprising:
receiving a user input, via an input device included in the electronic device;
identifying, via a processor, a function for executing the user input, based at least on input data corresponding to the user input;
classifying, via the processor, the identified function based on executability of the function;
determining, via the processor, a completion possibility of the classified function; and
providing response data, via an output device included in the electronic device, based on a result of the classifying and the completion probability.

12. The method of claim 11, wherein determining the completion possibility further includes:
determining whether input of a parameter for executing the function is required, based on the input data.

13. The method of claim 12, wherein providing the response data further includes:
when the input of the parameter is required, outputting a prompt requesting input of the parameter.

14. The method of claim 13, wherein the parameter is for at least one of a domain for executing the user input, or for executing an intent of the domain.

15. The method of claim 11, wherein the function for executing the user input is identified using natural language processing on the user input.

16. The method of claim 11, further comprising:
executing a capsule or a domain that supports a conversational input mode, based at least in part on the user input.

17. The method of claim 11, further comprising:
detecting an intent of a user based on the user input;
determining whether the detected intent of the user matches the identified function; and
when the detected intent fails to match the identified function, classifying the identified function as an unavailable function.

18. The method of claim 17, further comprising:
for the identified function that matches the detected intent, determining an accuracy value of the match with the detected intent; and
when the accuracy of the match is less than or equal to a threshold value, classifying the identified function as an inaccurate function.

19. The method of claim 18, further comprising:
determining whether the identified function is an interrupt function; and
when determining that the identified function is the interrupt function, classifying the identified function as a non-executable function.

20. The method of claim 19, further comprising:
classify any remaining function as a normal function that is not classified as the unavailable function, the inaccurate function and the non-executable function;
determine whether there are at least two functions classified as normal functions; and
when the at least two functions are classified as normal functions, determine whether the at least two functions include an interaction with each other.
